(19) United States
(12) Patent Application Publication
(10) Pub. No.: US 2021/0238787 A1
(43) Pub. Date: Aug. 5, 2021

(54) Appliance Comprising Weight Sensing Technology

(71) Applicant: Clarence Wheeler, Atlanta, GA (US)

(72) Inventor: Clarence Wheeler, Atlanta, GA (US)

(73) Assignee: Nurpsphere Inc, Atlanta, GA (US)

(21) Appl. No.: 17/145,934

(22) Filed: Apr. 18, 2021

Related U.S. Application Data
(63) Continuation-in-part of application No. 16/266,112, filed on May 26, 2019, now Pat. No. 10,995,443.

(51) Int. Cl. D06F 34/18; D06F 34/05; D06F 37/30

(52) U.S. Cl. CPC D06F 34/18; D06F 2103/04; D06F 37/304; D06F 34/05

(57) ABSTRACT

The present invention discloses a system having a appliance and a manufacture server having one or more databases. The appliance can be used perform operations to wash and dry the one or more articles, the appliance also can perform task such as to obtain a article profile upon scanning a optical code on the article via a camera on the appliance. The manufacture server can be configure to obtain a article profile request signal from the appliance, the manufacture server may obtain the article profile from the one or more databases and distribute a article profile return signal to the appliance. Upon the appliance obtaining the article profile return signal a user may be able to execute one or more washing and/or drying task based upon the data obtained from the article profile request signal.

### BACKGROUND OF THE INVENTION

### Field of the Invention

This invention relates to the field of home appliances. More specifically, the invention comprises an improved home appliance which traditionally upgrades conventional washer/dryer appliances and system comprising weight sensing technology.

### BRIEF SUMMARY OF THE PRESENT INVENTION

The scope of the present invention relates to washing/drying appliances. The present invention has been made to overcome the above described problems of the prior arts, and accordingly, it is an object of the present invention to provide a washing/drying machine which comprises an pulsator arranged within the inner cabinet which comprises an plurality of spring induction holes and spring induction caps which may be used to allocate the pulsator to marginally flex downwardly to apply an force upon a sensing member apparatus for sensing the load capacity of articles stored within the inner drum portion thereby providing an more precise solution to determine the load capacity of articles within the inner drum.

The appliance further comprise an plurality of moving member coupled to the outer drum envisioned to raise/lower the outer drum to and from the load capacity sensing apparatus to obtain load capacity data depending on one mode of the appliance. For instance, when an user selects load capacity sensing mode the appliance controller sends an signal to a motor device to adjust the outer drum onto the load capacity sensing apparatus, in response the load capacity sensing apparatus transmits an return signal to the appliance controller reveling the sensed outer drum load capacity (e.g., weight) which is further shown on the appliance display. In conclusion, the present invention provide an solution that overcomes the shortcomings of determining the load capacity of articles that are stored within the inner drum of conventional appliances.

BRIEF DESCRIPTION OF THE SEVERAL VIEWS OF THE DRAWINGS

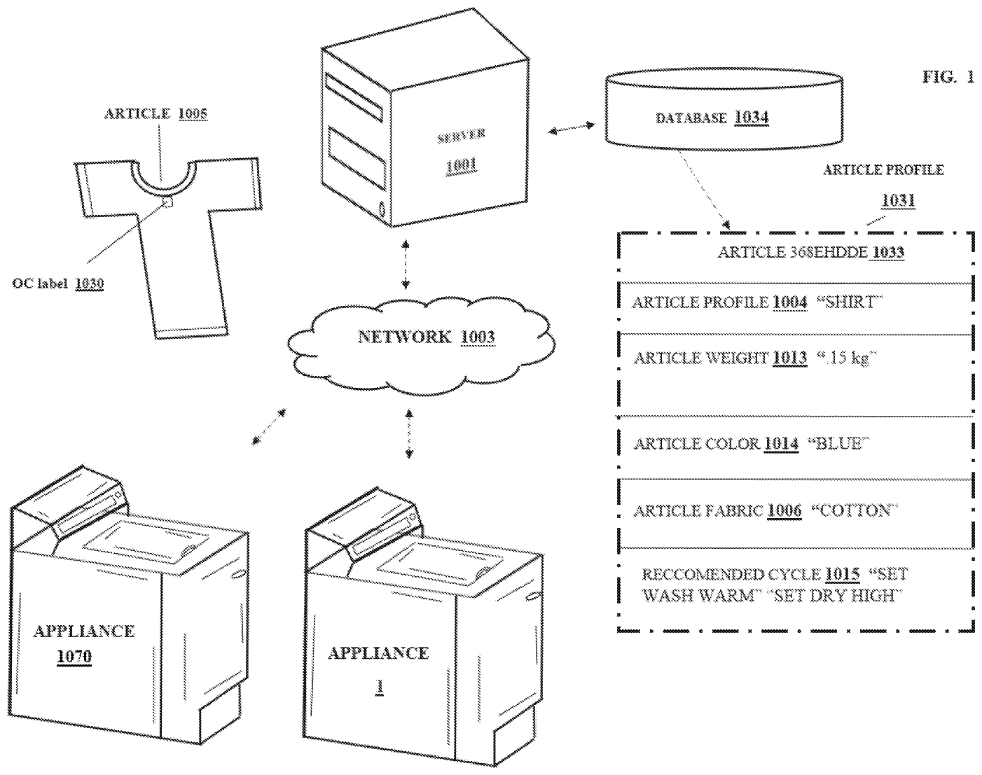

FIG. 1 is an perspective view of system according to one embodiment.

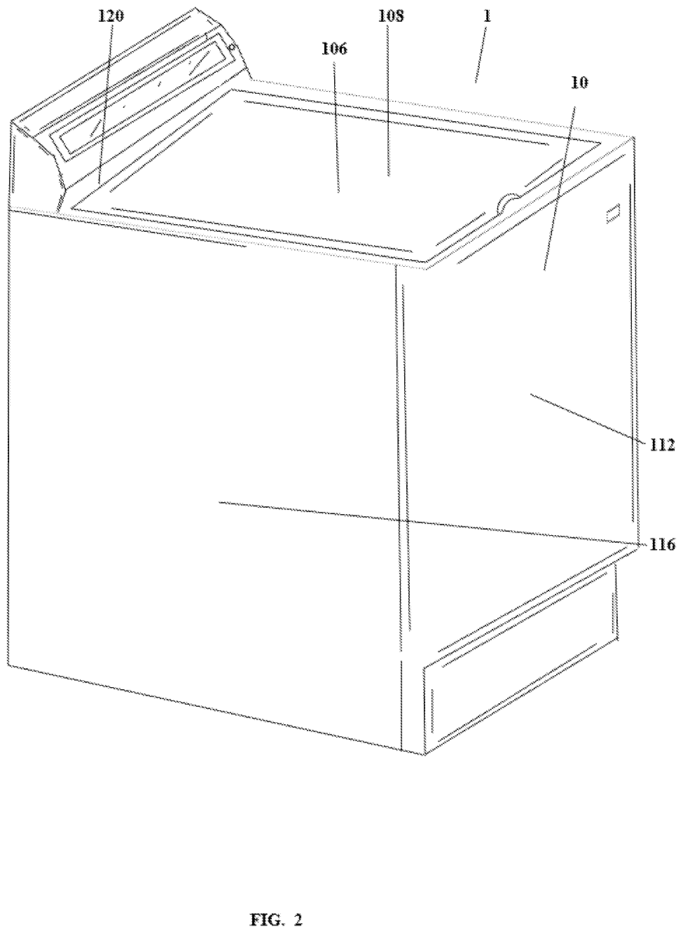

FIG. 2 is an perspective view of a appliance according to one embodiment.

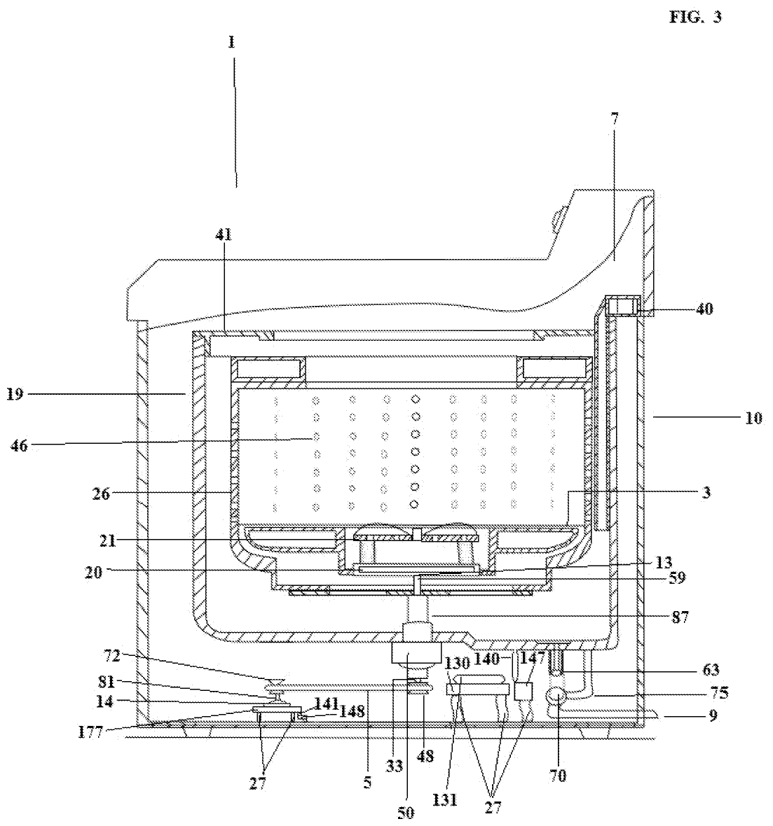

FIG. 3 is a schematic view of the appliance.

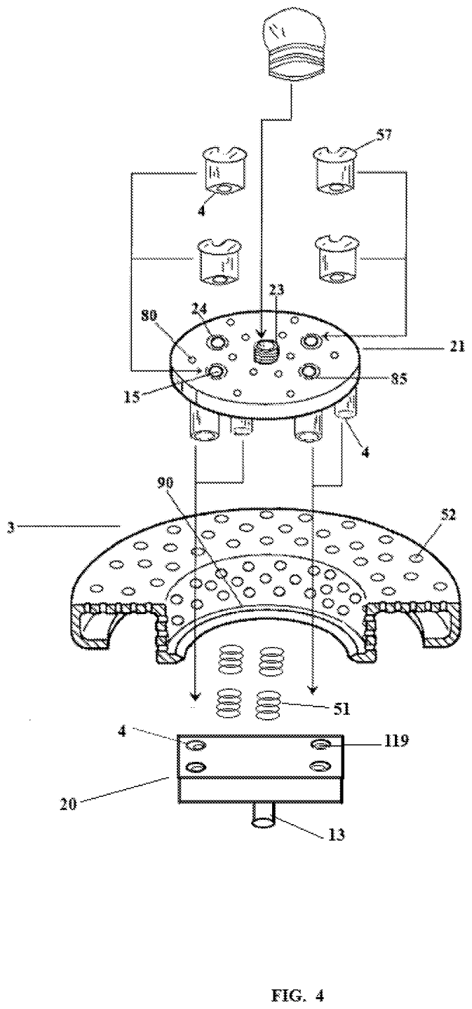

FIG. 4 is an perspective view of the pulsator, air guiding plate and sensing member according to one embodiment.

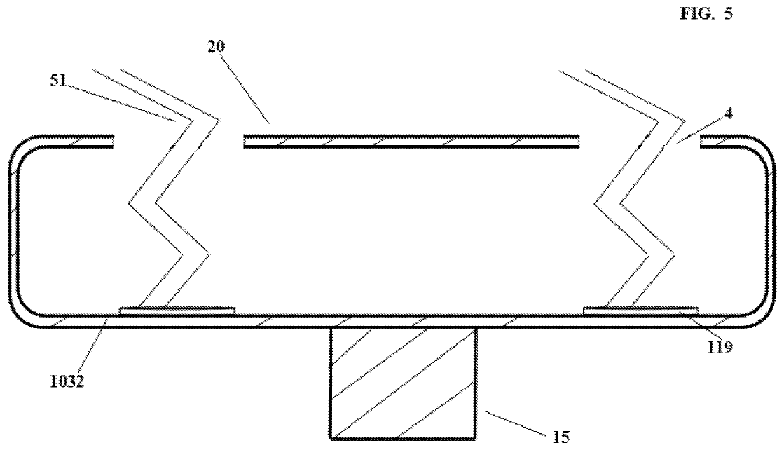

FIG. 5 is block diagram of the load capacity sensing apparatus.

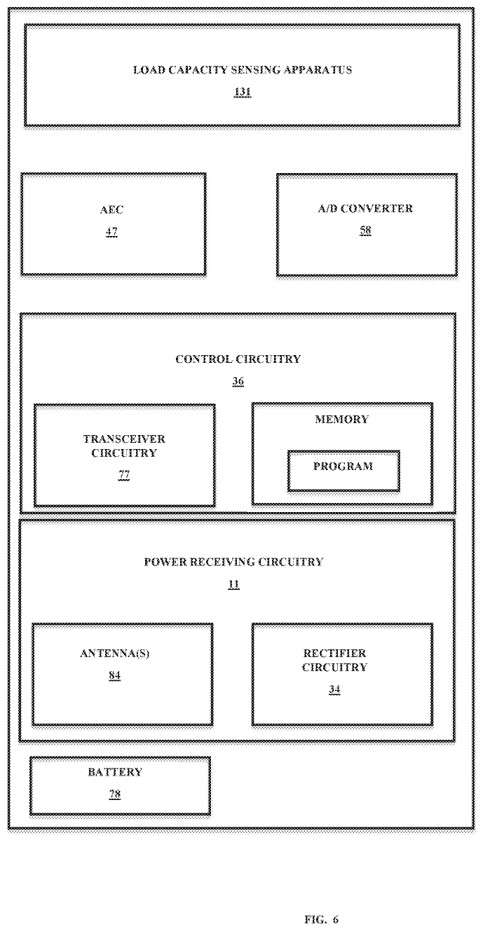

FIG. 6 is a schematic diagram of a hardware environment in which a drum control method according to an embodiment of the present disclosure.

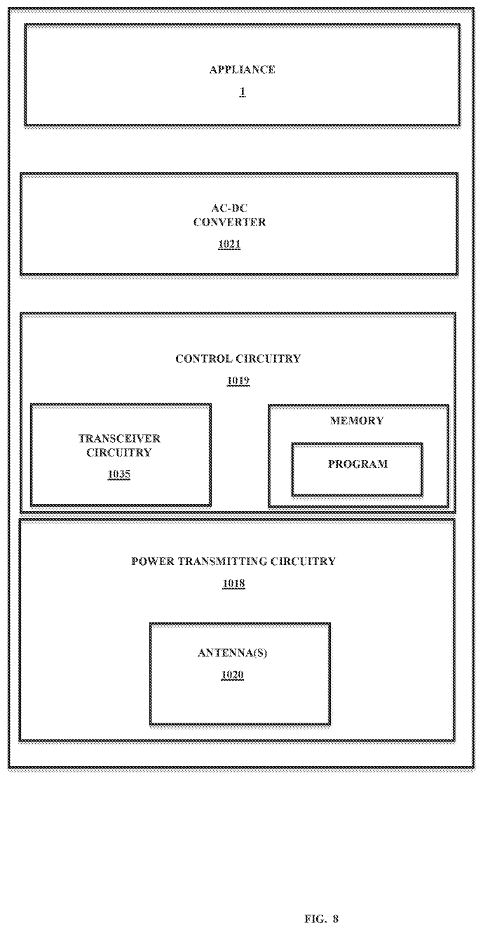

FIG. 8 is block diagram of the appliance of the system.

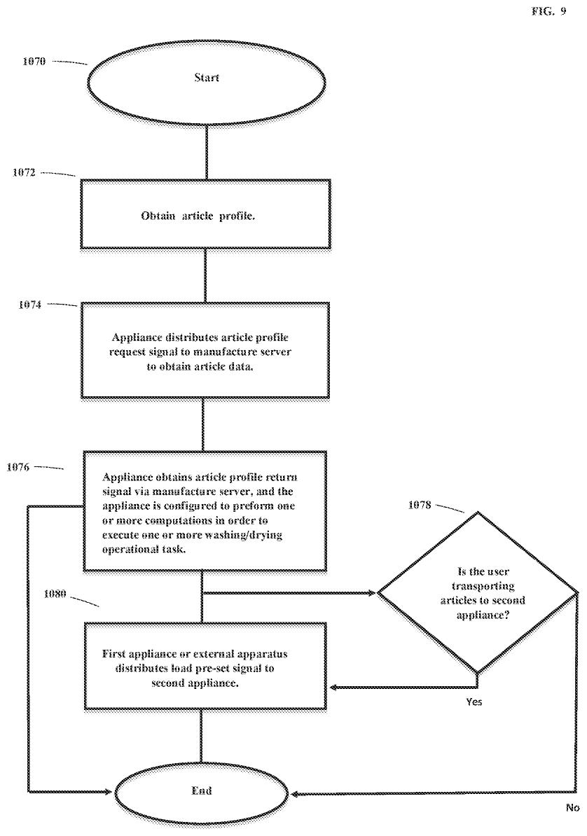

FIG. 9 is a flow chart of a method for controlling a operational aspect of the system according to the present invention.

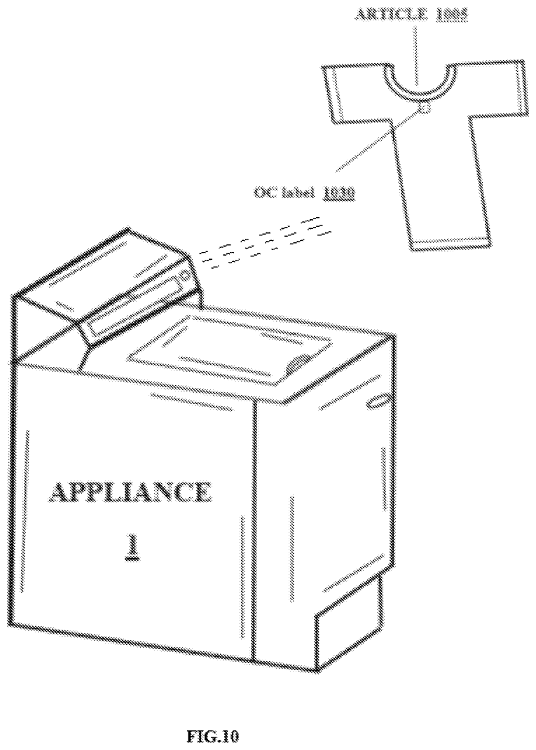

FIG. 10-15 is a illustration of the flow chart of a method for controlling a operational aspect of the system of FIG. 9.

### DETAILED DESCRIPTION OF THE PREFERRED EMBODIMENT(S)

FIG. 1 is an overview of system 1000. System 1000 comprises appliance 1, one or more articles 1005, manufacture server(s) 1001, article profile databases 1034 and network 1003 defining system 1000.

System 1000 includes one or more appliance(s) 1 in communication with one or more manufacture server(s) 1001 over network(s) 1003. In a preferred embodiment, appliance(s) 1 can be a washing machine, drying machine or an combination thereof. Appliance(s) 1 may be configured to obtain and display one or more article(s) profiles on display to execute a mode, washing and/or drying cycle. Appliance 1 may comprise an optical code scanner for scanning OC label 1030 disposed on article 1005 for obtaining article profile 1031 from one or more article manufacture server(s) 1001. For instance, OC label 1030 may be an additional label/tag on articles 1005 disposed on inner collar/neck, inner waist or an predetermine inner or outer region of the article 1005. OC label 1030 further comprises an optical code. The optical code may be a bar code, two-dimensional barcode (e.g., quick response (QR) code), or any other optical code. The optical code may encode a article identifier 1033 of the article corresponding to the optical code. The optical code may encode other information corresponding to the product such as the article profile 1031 which composes data indicating the article type 1004 (e.g., jeans, shirt, sock, jacket, shoes or undergarments), article weight 1013, article color 1014, article fabric 1006 and an predetermine recommended cycle 1015. Appliance 1 may be configured to communicate with the one or more manufacture(s) server 1001 via network 1003. Network 1003 may be embodied as a peer-to-peer wireless connection between appliance 1 and the one or more manufacture server(s) 1001, a connection through a local area network (LAN), Wi-Fi network, the Internet, or any other suitable communication medium or system.

For instance, in response to an user scanning an OC label 1030 disposed on the one or more articles 1005 via QR code reader (e.g. camera), appliance 1 is configured to generate and distribute an article profile request signal to manufacture/designer server 1001 under the control of control circuitry 1019. In response, to manufacture server 1001 obtaining the article profile request signal manufacture server 1001 is configured to obtain article profile 1031 from one or more article profile databases 1034 and generate and distribute an article profile signal to appliance 1 via network 1003.

System 1000 comprises manufacture server 1001, manufacture server 1001 may be integrated with any suitable components such as one or more microcontroller, processors, memory(s) and communication modules which may allocate manufacture server(s) 1001 to process instruction provided by one or more software, hardware, firmware, programs, application or an combination thereof to retrieve one or more article profile(s) 1031 from one or more article profile databases 1034 and distribute one or more article profile(s) 1031 to one or more appliances 1 via network (15). For instance, manufacture server(s) 1001 may be communicably coupled to one or more article profile databases 1034 over one or more network connections, such as over a storage area network connection, as an Fiber Channel interconnect, or as part of a local area network or a wide area network.

FIG. 2 illustrates appliance 1 of system 1000. It is appreciated that conventional appliances may also be stacked to each other in alternative embodiments. Appliance 1 includes cabinet 10 defining cavity 106 therein, outer drum and inner drum positioned within cavity 106, door 103 for closing cavity 106. In the exemplary embodiment, cabinet 10 includes front face 112, rear panel, respective side panels 116 spaced apart from each other by rear panel, bottom panel, and top panel 120.

Referring to FIG. 3, appliance 1 consists of cabinet 10 comprising at lease one laundry entrance such as an door arranged at its top-side to allocate an user to insert articles into the laundry entrance, upper frame 7 formed at cabinet 10 side wall.

Appliance 1 comprises outer drum 19 (e.g., such as the tub) disposed within cabinet 10 which may traditionally store water and washing liquid therein, and inner drum portion 26 (e.g., such as the drum) comprising an plurality of discharging holes 46 rotatably provided within outer drum 19, motor 14 coupled to bottom panel for generating a driving force, and gear assembly 50 which transfers the driving force from motor 14 to spin inner drum 26, or to pulsator 21 rotatably mounted on a bottom wall of inner drum 26. Motor device 14 is connected to gear assembly 50 through belt 5. Outer drum 19 is further configured to be movable from its original assembled position to adjusted position or adjusted position back to original assembled position by moving member 140 in response to processor generating and distributing motor control signal to motor 147.

Appliance 1 comprises spraying nozzle assembly 41 for spraying washing liquids into inner drum 26 mounted on an upper portion of outer drum 19. Assembled at a bottom wall of cabinet 10 is circulation pump 70 which is connected to outer drum 19 which may circulate washing liquids into spraying nozzle assembly 41, or in order to drain the washing liquids through drain tube 9 out of appliance 1.

Further, circulation pump 70 is connected to both outer drum 19 and spraying nozzle assembly 41 through discharging tube 63 and circulation tube 75 in order to circulate washing liquids into spray nozzle assembly 41, or otherwise drain washing liquids and water through drain tube 9.

Appliance 1 comprises air guide 40 coupled to upper frame 7 for guiding the air into the interior of appliance 1.

Generally, air guide 7 is made of a heat-resistant plastic material. A first end of air guide 40 is coupled to the inside wall of upper frame 7. Appliance 1 further comprises air guiding plate 3 mounted on an base portion of inner tub 26 which is traditionally used to allocate air flow towards inner tub 26.

Further, motor device 14 composes an respective motor shaft 81 and pulley 72 coupled to member 177 of bottom panel. Motor device 14 is further configured to be movable from its original assembled position to adjusted position or adjusted position back to original assembled position by moving member 141 in response to processor generating and distributing motor control signal to motor 148. Gear assembly 50 comprises an respective rotating shaft 33 and pulley 48 formed at its lower end. In sequence, gear assembly 50 pulley 48 is connected to pulley 72 by belt 5 whereas the rotational force of motor device 14 can be transmitted to gear assembly 50, Appliance 1 comprises an joining member 87 disposed at an upper region of gear assembly 50, further joining member 87 comprises sensing member rotating shaft 59 coupled to an upper portion of its body.

Sensing member rotating shaft 59 is respectively introduced into sensing member 20 base center hole 13. During operations of the washing cycles, gear assembly 50 distributes an rotational force from motor device 14 to pulsator 21 via sensing member rotating shaft 59 in conjunction with sensing member 20 being respectively coupled to pulsator 21.

Appliance 1 includes also comprises load capacity sensing apparatus 131 coupled to adjusting panel 177 coupled to suspension elements 27 configured to generate and distribute a load capacity signal to appliance 1 control circuitry in response to outer drum 19 assembling on load capacity sensing apparatus 131 based on a user selecting a wash and/or drying cycle or mode and moving member 140 retracting outer drum 19 downward. More specifically, load capacity sensing apparatus 20 may be a digital scale and/or comprises of components and developments as the likes of U.S. application Ser. No.: 09/360,331 and. U.S. Pat. No.: 5,886,302 for example.

According to FIG. 4 shows air guiding plate 3, pulsator 21 and sensing member 20. Air guiding plate 3 is respectively formed comprising an plurality of air guiding holes 52 throughout its circumference, and is formed at a center region of inner drum 26 thereof comprising annular recess 90.

Inner drum 26 comprises pulsator 21 respectively rotatably accommodated within annular recess 90, and further arranged at an upper surface thereof with a plurality of bores 80 which guides some of the air flow into a center region of inner drum 26. Pulsator 21 includes an first center hole 23 at an center region of its body thereof, in addition an portion of first center hole 23 outer circumference is threaded which may allocate pulsator 21 center cap 69 to couple thereon. Pulsator 21 comprises an plurality of spring induction hole(s) 15 throughout its top circumference respectively spaced slightly adjacent that forms an quadrilateral formation around first center hole 23. Spring induction hole(s) 15 comprises an partial annular recess region 85, and an partial lip 24 that flanges inward toward spring induction hole 15 opening so that spring induction caps(s) 57 edges rest thereon spring induction hole(s) 15 lip 24. Spring induction hole(s) 15 may be formed of a quadrilateral, spherical or elliptical shape.

More of, pulsator 21 comprises an plurality of spring induction cap(s) 57 that respectively corresponds and arrange within spring induction hole(s) 15. Additionally, the underneath region of each spring induction cap(s) 57 comprises spring slot(s) 4. Further spring slot(s) 4 forms an circular shape opening that slightly protrude downward away from spring induction cap(s) 57 body, envisioned to house coil spring(s) 51. The diameter of spring induction cap(s) 57 spring slot(s) 4 is marginally smaller than the overall diameter of coil spring(s) 51. In conclusion, the diameter of annular recess 90 may be larger than the outer diameter of pulsator 21, whereas this may allocate pulsator 21 to rotate spontaneously.

Appliance 1 includes sensing member 20 respectively coupled to but arrange below pulsator 21, sensing member 20 forms flat horizontal panel configured to generate a load capacity signal upon sensing a downward force from coil spring(s) 51.

Specifically, top side of sensing member 20 comprises an plurality of spring slog(s) 4. Spring slog(s) 4 forms an circular shape opening that slightly protrude upward in direction away from sensing member 20 body envisioned to house coil spring 51 that deviates and extends from spring induction cap(s) 57 spring slog(s) 4. Coil spring(s) 51 coupled within spring induction cap(s) 57 spring slog(s) 4 and platform 65 spring slog(s) 4 overall body is enclosed by an rubber bearing. The rubber bearing may be the like(s) of an sleeve made of an rubber or silicone material.

In addition, each spring slog(s) 4 comprises one or more sensors 119 penetrated through a bottom surface 1032 of spring slog(s) 4 configured to generate and distribute a load capacity signal to control circuit based upon a load capacity signal corresponding to the load of the article put on pulsator 21. Examples of sensors 119 may be a pressure sensor or the likes configured to generate a voltage signal under the influence of a pressure corresponding to the load (e.g., weight) of articles disposed on pulsator 21. This may be preformed by calculating the center of gravity based on the load (e.g., weight) sensed by the respective sensors 119 FIG. 5.

Further, sensing member 20 comprises, circle shape base center hole 13 that slightly protrudes away from bottom surface. Moreover, disposed below outer drum 19 is motor device 14 which traditionally generates and distributes a driving force to gear assembly 50 to spin inner drum 27 and pulsator 21 in response to pulsator 21 being respectively coupled to sensing member 20.

Referring to FIG. 6 load capacity sensing apparatus 131, comprises an quadrilateral-shape housing (not shown) including an platform (not shown) elevated by respective supports (not shown) at predetermine positions corresponding to the perimeter regions of platform (not shown). Platform (not shown) refers to the top surface of housing (not shown) which contains all of the analog and digital electronic circuitry, sensor devices and other components for load capacity sensing apparatus 131, further each support (not shown) can comprise load cell sensor (not shown) which contains a sensor plate with strain gauges in conventional fashion, the strain gauges can be typically intercoupled in a conventional bridge configuration, wherein one leg includes strain gauges T1 and C1 in tension and compression respectively, while the opposing leg includes strain gauges C2 and T2 in compression and tension respectively, under load conditions. More of, load cell assembly sensors may operate to sense an force resulting from pulsator and/or outer drum resting on platform and generates an analog signal indicative of the sensed force.

Further, load capacity sensing apparatus 131 analog signal may be input into an conventional analog electronic circuitry for an signal calibration or amplification and the likes for conditioning an sensed analog signal. The processed analog signal may be output from AEC (Analog Electronics Module) 47 for input into analog format to digital converter 58 for converting the analog format into an digital format.

Load sensing capacity apparatus 131 further comprises control circuitry 36 disposed within its housing and operates in response to Analog/Digital (A/D) converter 58 which provides digitized sensor input data from load cell sensor(s) 82 for generating a digital signal input to processor 29 to display an load capacity number value on display 132.

Control circuitry 36 may be used in controlling the operation of load capacity sensing apparatus 131. Control circuitry 36 may include an processing circuitry associated with microprocessors, power management units and/or applications—specific integrated circuits with processing circuits. For example, the processing circuitry may be used in determining processing sensor data (load cell sensors), handling negotiations between load capacity sensing apparatus 131 and processor 29 and processing other information and using this information to adjust one or more operation of the washing or drying cycles of appliance 1. Control circuitry 36 may be configured to perform operations in load capacity sensing apparatus 1 using hardware, firmware and/or software.

Software codes for performing operations in load capacity sensing apparatus 131 is stored on non-transitory computer readable storage media (e.g., tangible computer readable storage media) in control circuitry 36. The software codes may sometimes be referred to as software, data, program instructions, instructions, or code. The processing circuitry may include application-specific integrated circuits with processing circuitry, one or more microprocessors, a central processing unit (CPU) or other processing circuitry.

Control circuitry 36 may be used to run software, such as applications and operating system functions, etc. For, instance control circuitry 36 may comprises an application or software that obtains the digital signal via. Analog/Digital (A/D) converter 58 and converts the data into an actual number value, in response control circuitry 36 may distribute the number value to appliance 1 control circuitry to be stored in its memory or shown on the display. The communications protocols that may be implemented using control circuitry 36 includes Internet protocols, wireless local area network protocols (e.g., IEEE 802. 11 protocols sometimes referred to as WiFi®).

Load capacity sensing apparatus 131 may comprises power receiving circuitry 11 which obtains radio frequency signals via antenna 84 and harvest wireless power via the radio-frequency signals using rectifier circuitry 34, this may be possible by power transmitting circuitry 133 distributing power signals to power receiving circuitry 11. The radio frequency signals may be conveyed at any desired frequency.

Rectifier circuitry 34 converts receives radio-frequency signals (sometimes referred to as wireless power signals or wireless charging signals) from antenna 84 into DC voltage signals for powering load capacity sensing apparatus 131. DC voltages produced by the rectifier circuitry 34 can be used in powering battery 78 and can be used in powering other components in load capacity sensing apparatus 131.

Load capacity sensing apparatus 131 comprises transceiver circuitry 77 that may handle 2.4 GHz and 5 GHz bands for WiFi® (IEEE 802.11) communications.

For instance, transceiver circuitry 77 may include an circuitry for obtaining radio signals, paging system transceivers, near field communications (NEC) circuitry, etc. Further, in WiFi® links wireless signals can be typically used to convey data over an suitable distance according to feet. Transceiver circuitry 77 may also handle communications of wireless charging signals at any desired frequency.

Antennas 84 may be formed using any suitable antenna types. For instance, one type of antenna may be used to form a local wireless link antenna and an opposing type of antenna may be used in forming a remote wireless link antenna. Antennas 84 can include one or more antennas for handling transfer of wireless power signals as well.

Control circuitry 36 further comprises an wireless transceiver circuitry to wirelessly transmit out-of-band signals (e.g., radio-frequency signals at a different frequency from wireless power signals) to the load capacity sensing apparatus 131 using an antenna. Appliance 1 wireless transceiver circuitry may be used to wirelessly receive out-of-band signals from load capacity sensing apparatus 131 via an antennas. Load capacity sensing apparatus 131 may use wireless transceiver circuitry 25 to transmit out-of-band signals to appliance control circuitry. The receiver circuitry in wireless transceiver 25 may use an antenna to receive out-of-band signals from appliance 1 control circuitry.

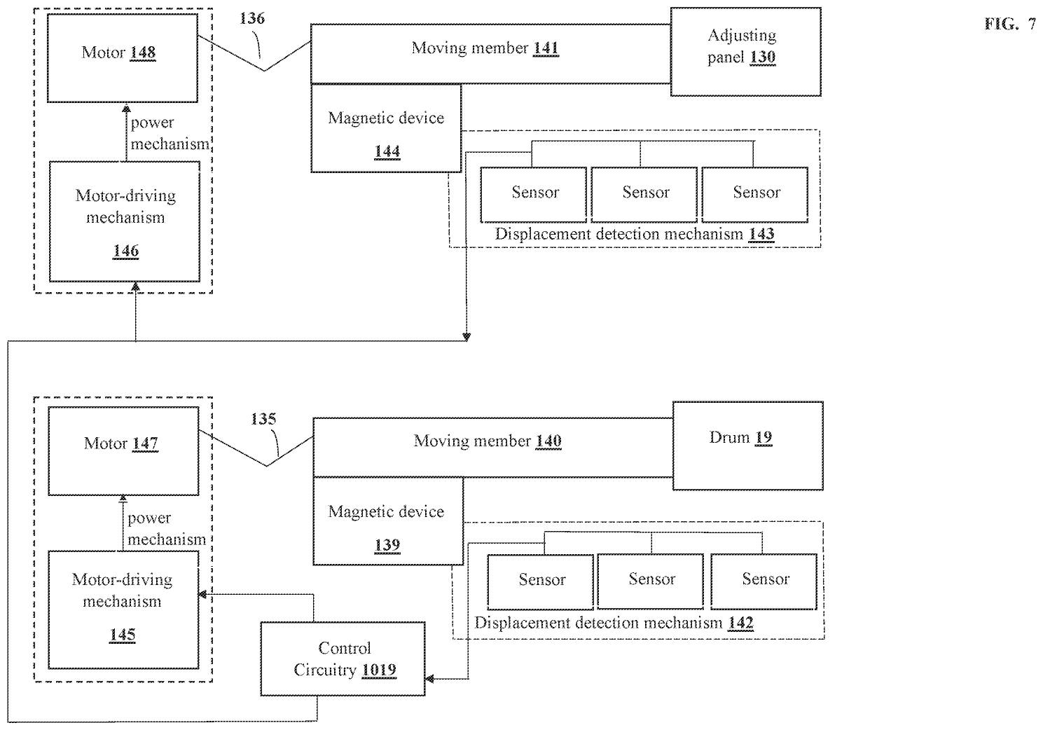

Referring to FIG. 7, FIG. 7 is a schematic diagram of a hardware environment in which adjustment assembly may be coupled to outer drum 19 and adjusting panel 130 and control method according to an embodiment of the present disclosure may be applied. As shown in FIG. 7, hardware environment includes outer drum 19, adjusting panel 130, moving member 140 & 141, elastic transmission mechanism 135 & 136, power mechanism 137 & 138, displacement detection mechanism 142 & 143, processor 29, display 132 and magnetic device 139 & 144. Outer drum 19 and adjusting panel 130 may be connected to power mechanism 137 & 138 through moving member 140 & 141 and elastic transmission mechanism 135 & 136. Power mechanism 137 & 138 includes motor-driving mechanism 145 & 146 and motor 147 & 148. Motor-driving mechanism 145 & 146 is used to drive motor to rotate so as to control movement of outer drum 19 and adjusting panel 130. Elastic transmission mechanism 135 & 136 may be a spring having a preload set to actual conditions.

Moving member 140 & 141 is provided with magnetic device 139 & 144. Displacement detection mechanism 142 & 143 may be able to determine displacement of outer drum 19 and adjusting panel 130 by detecting displacement of magnetic device 139 & 144, Displacement detection mechanism 142 & 143 may include one or at least two displacement sensors. Processor 29 is connected to power mechanism 137 & 138 and displacement detection mechanism 142 & 143 respectively. In one embodiment of the present disclosure, when adjusting (e.g., extending) outer drum 19 and adjusting panel 130 from original assembled position to adjusted position or to retracting outer drum 19 and adjusting panel 130 back to original assembled position from adjusted position, processor 29 may generate and distribute a motor control signal to motor-driving mechanism 145 & 146. Signifying the motor control signal, motor-driving mechanism 145 & 146 drives motor 147 & 148 to rotate, thereby moving elastic transmission mechanism 135 & 136 and moving member 140 & 141 and then further pushing outer drum 19 and adjusting panel 130 to move in a direction of extending from the original assembled position to the adjusted position or to move in a direction of retracting outer drum 19 and adjusting panel 130 back to the original assembled position from the adjusted position. During this point, displacement detection mechanism 142 & 143 may detect a displacement amount of magnetic device 139 & 144 in real time and feed back displacement amount to processor 29. Processor 29 may obtain a displacement amount of outer drum 19 and adjusting panel 130 according to corresponding relationship between the displacement amount of magnetic device 139 & 144 and the displacement amount of outer drum 19 and adjusting panel 130. The displacement detection mechanism 142 & 143 may also directly detect the displacement amount of outer drum 19 and adjusting panel 130 and feed back the displacement amount to processor 29. Processor 29 may control the rotation of motor 147 & 148 in accordance with the amount of displacement of outer drum 19 and adjusting panel 130.

FIG. 8 is block diagram of the appliance of the system. Appliance 1 includes control circuitry 1019 used in controlling the overall operations of appliance 1. Control circuitry 1019 may include an processing circuitry associated with microprocessors, power management units and/or applications—specific integrated circuits with processing circuits. For example, the processing circuitry may be used in determining and executing a washing and/or drying task, handling negotiations between load capacity sensing apparatus 131 and appliance 1, appliance 1 and servers or processing other information and using this information to adjust one or more operation of the washing or drying cycles of appliance 1. Control circuitry 36 may be configured to perform operations in appliance 1 using hardware, firmware and/or software. Software codes for performing operations in appliance 1 is stored on non-transitory computer readable storage media (e.g., tangible computer readable storage media) in control circuitry 1019. The software codes may sometimes be referred to as software, data, program instructions, instructions, or code. The processing circuitry may include application-specific integrated circuits with processing circuitry, one or more microprocessors, a central processing unit (CPU) or other processing circuitry.

Control circuitry 1019 may be used to run software, such as applications and operating system functions, etc. For, instance control circuitry 1019 may comprises an application or software that obtains the load capacity signal from transceiver circuitry 77 (FIG. 6) in response to sensing member 20 or load capacity sensing apparatus 131 sensing a force and displaying the number value on display or storing the number value in its memory. Control circuitry 1019 may also obtain request article profiles from server and input article profile and use the data to execute a washing and/or drying task and mode based off data obtained from server. The communications protocols that may be implemented using control circuitry 1019 includes internes protocols, wireless local area network protocols (e.g., IEEE 802.11 protocols—sometimes referred to as WiFi®).

Appliance 1 may be coupled to a wall outlet (e.g. alternating current), may have a battery for supplying power, and/or may have another source of power, Appliance 1 may have an AC-DC power converter such as power converter 1021 for converting AC power from a wall out let or other power source into DC power. The DC power may be used to power control circuitry 1019 and other components in appliance 1. Controller in control circuitry 1019 may use power transmitting circuitry 1018 to transmit wireless power to power receiving circuitry 11 (FIG. 6) via antennas 1020.

Appliance 1 comprises transceiver circuitry 1035 that may handle 2.4 GHz and 5 GHz bands for WiFi® (IEEE 802.11) communications. For instance, transceiver circuitry 1035 may include an circuitry for obtaining radio signals, paging system transceivers, near field communications (NFC) circuitry, etc. Further, in WiFi® links wireless signals can be typically used to convey data over an suitable distance according to feet. Transceiver circuitry 1035 may also handle communications between load capacity sensing apparatus 131, sensing member 20 and server. Referring to FIG. 9, FIG. 9 illustrates a flow chart for implementing the method for Controlling appliance 1 of system 1000 according to the present invention, As previously mentioned system 1000 comprises first appliance 1 and second appliance 1070, one or more articles, manufacture server(s) 1001, article profile databases 1002 and network 1003 defining system 1000.

At 1072 of method 1070, user obtains article profile data of one or more articles 1005. Article profile data can be obtained by way of user activating sensing mode program 1007 FIG. 10.

Specifically, during activation of sensing mode program 1007 control circuitry 1019 activates camera and the user is traditionally able to scan QR code on one or more articles 1005.

Further, upon scanning one or more articles 1005 control circuitry 1019 can be configured to generate graphical user interface 1008 having input chart 1071 with selectable fields. Chart 1071 can comprise one or more fields that displays article 1005 data, such data can be article identifier 1075, article type 1006 and a virtual representation 1010 of each article 1005. Chart 1071 can also include one or more input buttons for removing one or more articles 1005 from chart 1071. Removing one or more articles 1005 from drum can be executed by a user pressing the remove button and rescanning the desired article 1005 and control circuitry 1019 is configured to delete the one or more articles from chart 1071. Graphical user interface 1008 can include a input button (e.g., start/stop button) for executing and stopping the predetermine washing and/or drying cycles.

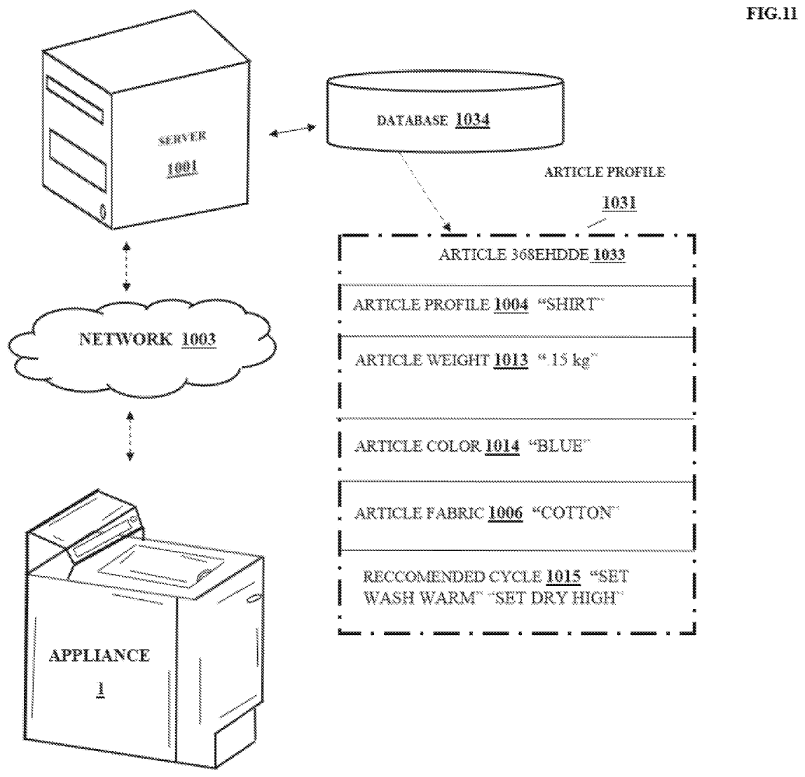

At 1074, upon control circuitry 1019 activating camera 1009 scanning QR code, control circuitry 1019 is configured to generate and distribute article profile request signal to manufacture server(s) 1001 manufacture server(s) 1001 obtains article profile 1031 from one or more article profile databases 1002, and manufacture server(s) 1001 generates and distribute a article profile return signal to first appliance 1 or second appliance 1070 via network 1003. Each article profile request signal can comprise a identifier that distinguish each respective article 1005 from another in order to determine the profile of respective articles 1005. As previously mentioned, each article profile stored in article profile databases 1002 includes respective files composing data indicating such as the article type 1004 (e.g., jeans, shirt, sock, jacket, shoes or undergarments), article weight 1013, article color 1014, article fabric type 1006 and predetermine recommended cycle 1015 FIG. 11.

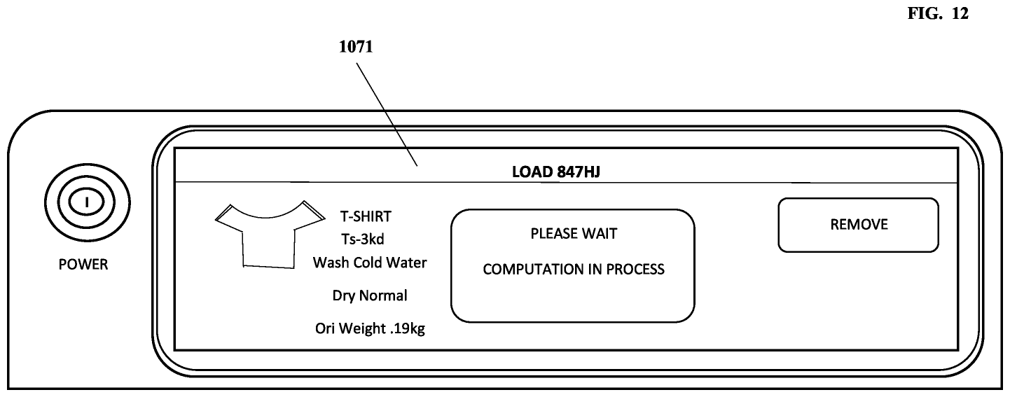

At 1076, once each article profile return signal is obtained for each respective article 1005 by first appliance 1 or second appliance 1070, control circuitry 1019 input article profile data into chart 1071 as described above, and configured to preform one or more comparison task in order to determine if the one or more article 1005 comprises the same predetermine recommended cycles 1015. If control circuitry 1019 determines each respective article 1005 comprises similar predetermine recommended cycle 1015 users is prompted to execute predetermine recommended cycle 1015 by pressing start input button or the predetermine recommended cycle is executed automatically. If control circuitry 1019 determines each respective article 1005 doesn't comprises similar predetermine recommended cycles 1015 users is prompted on graphical user interface to set there own predetermine cycle FIG. 12.

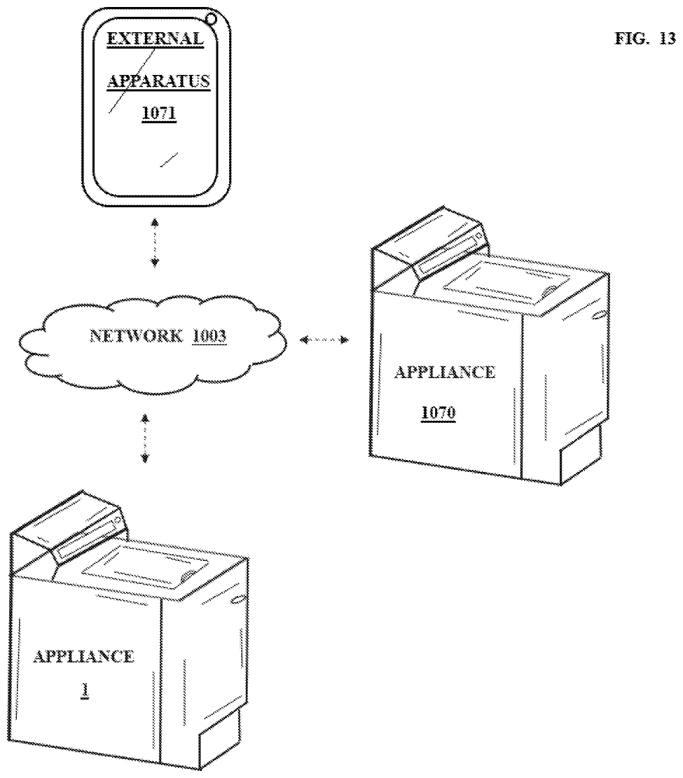

At 1078, in sonic instances, if first appliance 1 is a stand alone washing machine and second appliance 1070 is a stand alone drying machine and the user is in the process of washing and drying one or more articles 1005, one or more articles 1005 will have to be transported from first appliance 1 to second appliance 1070. Upon first appliance 1 obtaining each article profile return signal and control circuitry 1019 determining each respective article 1005 comprises similar predetermine recommended cycle 1015 control circuitry 1019 can be executed to distribute a load pre-set signal (e.g., data comprising the predetermine recommended cycle 1015 and one or more original articles weight) to external apparatus 1071 and/or second appliance 1070 via network so that when second appliance 1070 is turned on and loaded with one or more articles 1005 the first appliance 1 or external apparatus 1071 can distribute the load pre-set signal to the second appliance 1070 via network which will keep the user from rescanning each article 1005 when transported from the first appliance 1 to second appliance 1070 and the drying operations of second appliance 1070 is pre-set and ready to start without the need for manual adjustment of the user FIG. 13.

At 1080, once load pre-set signal is obtained by control circuitry 1019 of second appliance 1070, control circuitry 1019 input article profile data into chart 1071 as described above, and preforms one or more comparison task in order to determine if the one or more article 1005 comprises the same predetermine recommended cycles 1015 (e.g., dry task). If control circuitry 1019 determines each respective article 1005 comprises similar predetermine recommended cycle 1015 users is prompted to execute predetermine recommended cycle 1015 by pressing start input button or the predetermine recommended cycle is executed automatically. If control circuitry 1019 determines each respective article 1005 doesn't comprises similar predetermine recommended cycles 1015 users is prompted on graphical user interface to set there own predetermine cycle.

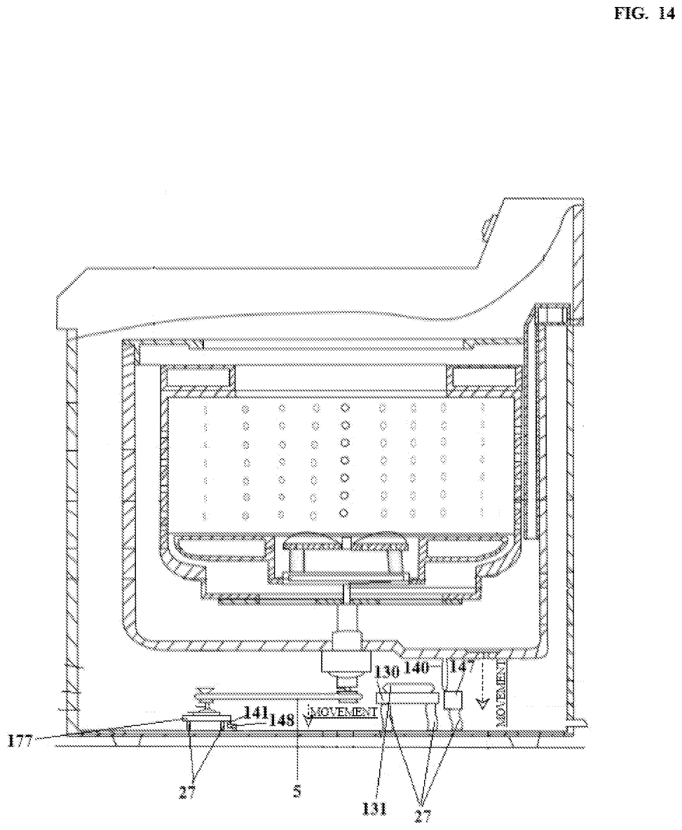

However, before the drying task is executed by first appliance 1 (e.g., if first appliance 1 is washer/drying combination unit) or second appliance 1070 control circuitry 1019 is configured to generate and distribute motor control signal to motor driving mechanism 145 & 146 to drive motor 147 & 148 to rotate, thereby moving elastic transmission mechanism 135 & 136 and moving member 140 & 141 and further slightly retracting outer drum 19 in a direction down to assemble on load capacity sensing apparatus 131 and slightly retracting adjusting panel 130 in a direction down from the original assembled position to the adjusted position slightly removing tension from belt 5 to restrict disfiguration or breakage of belt 5 FIG. 14.

In conjunction with control circuitry 1019 generating and distributing motor control signal to motor driving mechanism 145 & 146, control circuitry 1019 is further configured to preform one or more computations to determine the respective load of damp articles 1005 original dry weight. Specifically, control circuitry 1019 can be configured to calculate the total ADW (e.g., total value of each article 1005 dry weight of the load) and add the ADW (e.g., total value of each article 1005 dry weight) value to the EDW (e.g., empty drum weight) in order to determine the CDCW value (e.g., complete dry cycle weight value). It is noted, the ADW (e.g., total value of each article 1005 dry weight) value may be obtained upon second. appliance 1070 obtaining load pre-set signal since load pre-set signal comprises the same data. as the article profile signal. It is also noted that control circuitry 1019 memory may already have EDW (e.g., empty drum weight) stored in memory from manufacturer for computations purposes.

For instance, the weight of the drum empty may be 27 kg in this instance the EDW is 27 kg For example, the respective load may comprise of 10 articles 1005 (e.g., T-shirts) weighting 0.19 kg each and totaling 1.9 kg in this instance the ADW is 1.9 kg. Upon control circuitry 1019 determining the ADW and EDW, control circuitry 1019 preforms computation 1.9 kg ADW+27 kg EDW=28.9 CDCW which determines the value at which the dry cycle ends upon control circuitry 36 distributing load capacity return signal to control circuitry 1019.

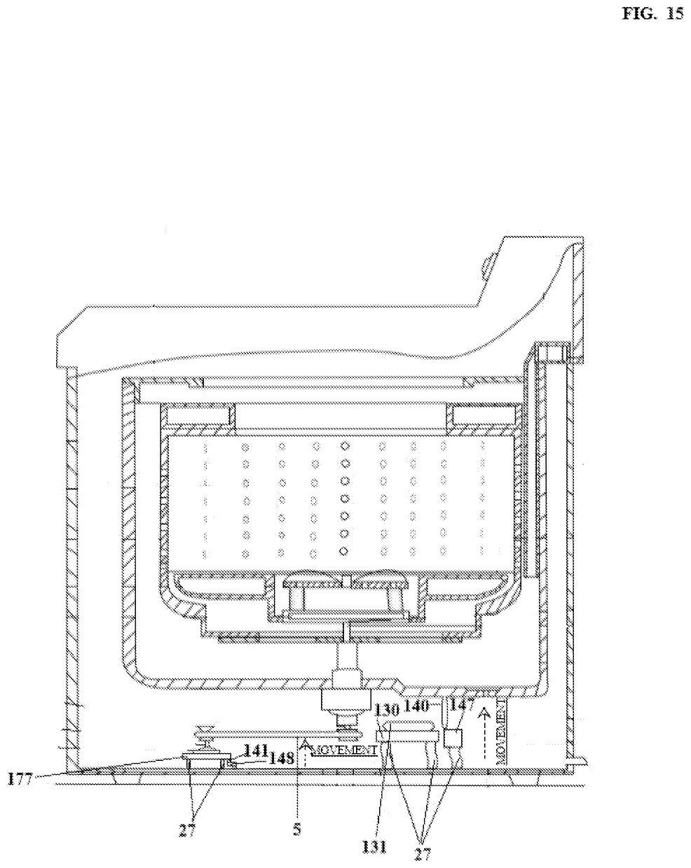

Once the CDCW (e.g., complete dry cycle weight value) value is determined control circuitry 1019 is further configured generate and distribute load capacity request signal to control circuitry 36 of load capacity sensing apparatus 131 to obtain the total DIN (e.g., load capacity value of each damp article 1005 and drum value upon obtaining load capacity signal), upon control circuitry 1019 obtaining load capacity signal containing DLV (e.g., load capacity value of each damp article 1005 and drum value upon obtaining load capacity signal) control circuitry 1019 is configured display DLV (e.g., damp load value of each article 1005 and drum value upon obtaining load capacity signal) on display. During drying operations of the respective load control circuitry 1019 is configured to perpetually generate and distribute load capacity request signals to control circuitry 36 of load capacity sensing apparatus 131 until control circuitry 1019 obtains a value the same as the CDCW (e.g., complete dry cycle weight value), upon obtaining the same value as CDCW (e.g., complete dry cycle weight value) the drying operation are stopped and control circuitry 1019 generates and distributes motor control signal to motor driving mechanism 145 & 146 to drive motor 147 & 148 to rotate, thereby moving elastic transmission mechanism 135 & 136 and moving member 140 & 141 and further slightly adjusting outer drum 19 in a upward direction to assemble off load capacity sensing apparatus 131 and slightly adjusting adjusting panel 130 in a upward direction from the adjusted position to the original assembled position slightly removing tension from belt 5 to restrict disfiguration or breakage of belt 5 FIG. 15.

Although the preceding description contains significant detail, it should not be constructed as limiting the scope of the invention but rather as providing illustrations of the preferred embodiments of the invention. Thus, the scope of the invention should be fixed by the following claims rather than any specific examples provided.

What is claimed is:

1. An system comprising:
a appliance comprising one or more memories communicable couple to a control circuitry, the one or more memories storing executable instructions that causes the control circuitry to:
scan a optical code corresponding to a article for which a manufacturing server has a article profile;
obtain a article profile return signal from the manufacturing server; and wherein the article profile signal comprises article profile data;
preform one or more computations to determine a load capacity value at which a washing and dry cycles ends;
a moving member coupled to a outer drum, and wherein the moving member is configured to adjust the outer drum from a original assembled position to a adjusted assembled and to adjust the outer drum from the adjusted assembled position back to the original assembled position, and wherein the adjustment of the outer drum is based upon a user executing a mode and the control circuity generating and distributing a motor control signal to motor driving mechanism 145 to drive a motor rotate and move a elastic transmission mechanism 135 and the moving member 140;
a pulsator disposed within the appliance having spring induction holes for housing a spring induction caps;
a spring induction cap disposed within the one or more induction holes, and wherein the spring induction cap comprises a spring slot extending from the spring induction cap body configured to house a coil spring; and wherein the spring slot is formed of a shape; and
an sensing member apparatus disposed within the appliance having a top side, and wherein the top side comprises a plurality of spring slots formed of a shape extending from the top side, and wherein the plurality of spring slots is configured to communicable couple the sensing member to the pulsator by receiving the coil springs deviating the spring induction caps spring slots;
wherein the appliance is configured such that during operations of washing and/or drying cycles a gear assembly distributed rotational force from a motor device to the pulsator, and wherein the rotational force is distributed to the pulsator via a sensing member rotation shaft communicable coupled to a base center hole formed on the sensing member;
wherein the appliance is configured such that when the pulsator flexes downward in motion in response to sensing a force from a object placed in the inner drum, and wherein the force applied to the pulsator is applied to the sensing member in response to the coil spring constitution a compressed state, and wherein the sensing member is configured to generate and distribute a load capacity signal to a control circuitry in response to sensing the force from the pulsator in response to the pulsator sensing a force from the object place in the inner drum;
wherein the appliance is configured in a way that when the control circuitry generates and distributes the motor control signal to motor driving mechanism 145 to adjust the outer drum the control circuitry also generates and distributes the motor control signal to a motor driving mechanism 146 to adjust a adjusting panel, and wherein the adjustment of the adjusting panel is based upon the user executing a mode and the control circuity generating and distributing the motor control signal to motor driving mechanism 146 to drive a motor to rotate and move a elastic transmission mechanism 136 and a moving member 141.

3. The system of claim 1, wherein the appliance comprises a camera, and wherein the executable instructions cause the one or more processors to scan the article using the camera based upon a user executing sensing mode.

4. The system of claim 1, wherein the executable instruction cause the one or more processors to distribute the article profile request signal to the manufacture server upon scanning the optical code.

5. The system of claim 1, wherein the article profile data comprises a article type, article weight, article color, article fabric type, and predetermine recommended cycle.

6. The system of claim 1, wherein the executable instruction further cause the one or more processers to preform the one or more computation of ADW+EWD=CDCW to determine the value when the wash/dry cycle ends.

7. The appliance of claim 1, wherein when the motor driving mechanism adjust the drum based upon the user executing sensing mode.

8. The appliance of claim 1, wherein the one or more spring induction hole(s) forms a quadrilateral formation around a first center hole.

9. The appliance of claim 1, wherein the one or more spring induction hole(s) is formed as a quadrilateral, spherical or elliptical shape.

10. The appliance of claim 1, wherein the spring slot(s) forms a circular shape,

11. The appliance of claim 1, wherein the sensing member spring slot(s) forms a circular shape.

12. The appliance of claim 1, wherein the sensing member spring slot(s) comprises one or more sensors penetrated through a bottom surface of the spring slot(s).

13. The appliance of claim 1, further comprising the coil spring(s) coupling the spring induction cap(s) spring slot(s) to the sensing member plurality of spring slot(s) body is enclosed by a rubber hearing.

14. The washer/dryer appliance of claim 1, wherein the circle shape base center hole slightly protrudes away from a body of the sensing member.

15. The appliance of claim 1, wherein the appliance is a washing machine.

16. The appliance of claim 1, wherein the appliance is a drying machine.

17. The appliance of claim 1, wherein the appliance is a washer/dryer combo machine.

18. An method of a system comprising:
Scan a optical code disposed on a articles to obtain a article profile;
obtaining, by a control circuitry, a article profile return signal from manufacture server, and wherein the article profile request signal comprises the article profile data, and wherein the article profile data is used to determine a predetermine wash/dry cycle and determine a article weight; and
generating and distributing, by a control circuitry, a motor control signal to a motor driving mechanism, and wherein the motor control signal is configured to rotate a motor thereby moving a elastic transmission mechanism and moving member to retract a outer drum downward to assemble a load capacity sensing apparatus, and wherein the motor control signal is generated and distributed to the motor driving mechanism based upon a user executing sensing mode; and
determining, by the control circuitry, a value at which washing and drying cycle end by preforming one or more computations, and wherein the one or more computations is ADW+EDW=CDCW.
